(19) United States
(12) Patent Application Publication
(10) Pub. No.: US 2002/0036876 A1
(43) Pub. Date: Mar. 28, 2002

(54) Magnetoresistive element, method for manufacturing the same, and magnetic device using the same

(76) Inventors: Yasuhiro Kawawake, Kyoto (JP); Yasunari Sugita, Osaka (JP); Akihiro Odagawa, Nara (JP); Akihisa Yoshida, Kyoto (JP); Hiroshi Sakakima, Kyoto (JP)

Correspondence Address: MERCHANT & GOULD PC, P.O. BOX 2903, MINNEAPOLIS, MN, 55402-0903, US

(21) Appl. No.: 09/946,643

(22) Filed: Sep. 4, 2001

(30) Foreign Application Priority Data
Sep. 6, 2000 (JP) 2000-270831

(51) Int. Cl. G11B 5/39

(52) U.S. Cl. 360/324.1; 29/603.14

(57) ABSTRACT

The invention increases the electric resistance of CPP-GMR elements to a practical range. Moreover, the invention presents a CPP-GMR element and a TMR element that can be applied to track widths that are made narrower due to higher densities of the magnetic recording. The area S₁ of a non-magnetic layer 7 is 1 μm or less, and at least one layer selected from a first magnetic layer 6, a second magnetic layer 8 and the non-magnetic layer 7 includes a first region 30 through which current flows and a second region 20 made of an oxide, a nitride or an oxynitride of the film constituting that first region. The area S₂ of the first region is smaller than the area of the non-magnetic layer. At least one of the layers of the element is oxidized, nitrided or oxynitrided from a lateral side.

### BACKGROUND OF THE INVENTION

1. Field of the Invention

The present invention relates to magnetoresistive elements (referred to as “MR elements” in the following) and methods for manufacturing them. The present invention also relates to magnetic devices using MR elements, such as magnetoresistive heads (referred to as “MR heads” in the following), and magnetic recording apparatuses (such as hard disk drives).

2. Description of the Related Art

To satisfy the demand for higher magnetic recording densities, magnetic read heads using GMR elements have been developed. And in order to make recording densities even higher, TMR (tunnel magnetoresistance) elements, in which the resistance changes are large and the resistance itself is much larger, are widely researched. TMR elements use an insulating layer as the non-magnetic layer, and utilize the tunneling current flowing through this insulating layer. Ordinarily, GMR elements operate used by letting the current flow parallel to the film surface (CIP-GMR; current in plane-GMR), but elements have been proposed in which the current flows perpendicular to the film surface (CPP-GMR; current perpendicular to plane-GMR), like in TMR elements. In CPP-GMR elements with Co/Cu, Co/Ag systems for example, the MR ratio is about five times higher than in CIP-GMR elements.

In CPP-GMR elements, a metal layer is used for the non-magnetic layer, and because the current flows perpendicular to the film surface, the resistance is too low to use it as a device. The resistance can be increased to some degree even in CPP-GMR elements by making the element smaller. However, CPP-GMR elements with sufficiently high resistance cannot be attained by merely making the element smaller with lithography techniques.

As magnetic recording densities become progressively higher, the track width in the recording medium becomes smaller. Therefore, the width of the region of the magnetic read head that reads the information by detecting the magnetism from the medium (referred to as “track response width” in the following) has to become narrower as well. For example, in high-density magnetic recordings of more than 100 Gbit/in², a track response width of less than 0.1 μm is necessary. However, as the track width becomes smaller, it will not be possible to keep up with lithography techniques alone, even when taking advances in this technology into consideration.

### SUMMARY OF THE INVENTION

It is an object of at least a preferable embodiment of the present invention to increase the electric resistance of CPP-GMR elements to a practical range. It is a further object of at least another preferable embodiment of the present invention to provide an MR element that can keep up with narrower band widths.

In order to attain these objects, a magnetoresistive element in accordance with the present invention includes a non-magnetic layer and a first and a second magnetic layer sandwiching the non-magnetic layer. In the element, a current for sensing a change in magnetic resistance based on a change in the relative angle between a magnetization direction of the first magnetic layer and the magnetization direction of the second magnetic layer flows perpendicular with respect to the layers. The element is characterized in that the non-magnetic layer has an area of not more than 1 μm², and that at least one layer selected from the first and second magnetic layers and the non-magnetic layer includes a first region through which said current flows and a second region made of an oxide, a nitride or an oxynitride of the material of which the first region is made, and that the first region is smaller than an area of the non-magnetic layer.

A method for manufacturing an MR element in accordance with the present invention includes forming the first magnetic layer, the non-magnetic layer and the second magnetic layer such that the non-magnetic layer has an area of not more than 1 μm², and oxidizing, nitriding or oxynitriding a portion of at least one layer selected from the first magnetic layer, the non-magnetic layer and the second magnetic layer from a lateral side.

When the present invention is applied to a CPP-GMR element, an element with sufficiently high resistance can be obtained. Moreover, the track response width of a magnetic head using this element can be restricted. The present invention is also advantageous for making the track response width of magnetic heads using a TMR element narrower. The present invention further provides a magnetic head (MR head) using this MR element and a magnetic recording apparatus using this magnetic head.

### BRIEF DESCRIPTION OF THE DRAWINGS

FIG. 1 is a cross section showing an MR element in accordance with the present invention.

FIG. 2 is a magnification of an MR element portion of the element in FIG. 1.

FIG. 3 is a cross section showing an example of a multilayer film for forming the element portion in FIG. 2.

FIG. 4 is a cross section illustrating a step (step of forming the layers) in a method for manufacturing the present invention.

FIG. 5 is a cross section illustrating the step of processing the layered product in FIG. 4.

FIG. 6 is a cross section illustrating the step of further processing the layered product in FIG. 5.

FIG. 7 is a cross section illustrating the step of partially oxidizing the layered product in FIG. 6.

FIG. 8 is a cross section illustrating the step of further forming an insulating film on the layered product in FIG. 7.

FIG. 9 is a cross section illustrating the step of forming an additional upper electrode on the layered product in FIG. 8.

FIG. 10 is a partial perspective view of a portion of an MR head in accordance with the present invention.

FIG. 11 is a partial perspective view of a conventional MR head.

FIG. 12 is a partial perspective view of a conventional MR head using a CIP-GMR element.

FIG. 13 is a plan view showing a magnetic recording apparatus in accordance with the present invention.

FIG. 14 is a cross section of the magnetic recording apparatus in FIG. 13.

### DESCRIPTION OF THE PREFERRED EMBODIMENTS

The following is a description of the preferred embodiments of the present invention, with reference to the accompanying drawings.

In accordance with the present invention, the resistance is increased or the track response width is made narrower by a second region made of an oxide film, a nitride film, or an oxynitride film. The area of the second region should be at least 10%, or even better at least 40% of the area of the non-magnetic layer. The second region is formed in at least one layer of an MR element, in which the area of the non-magnetic layer has been somewhat reduced in size to 1 μm² or less. Applying the present invention to an MR element, in which the area of the non-magnetic layer is further minimized to 0.1 μm² or less or preferably 0.01 μm² or less, even better results can be obtained.

If the present invention is applied to CPP-GMR elements, then at least the non-magnetic layer should be provided with a first region and a second region. In that case, the first region of the non-magnetic layer is a metal film, preferably a film having at least one selected from Cu, Ag, Au, Ir, Ru, Rh and Cr as its main component. It should be noted that in this specification “main component” means a component that accounts for at least 50 wt %.

The second region is a film of an oxide, nitride or oxynitride of the metal constituting the first region. The conductive region (first region) of the non-magnetic layer is restricted by the second region, so that the resistance of the element increases. When the element is simply microprocessed, there is a limit to how much the resistance can be increased. For example, in an element that has been processed to 100 nm×100 nm (i.e. 0.01 μm² element surface area), when the film thickness is set to 50 nm and the specific resistance is 30 μΩcm, the element resistance is still about 1.5Ω. On the other hand, applying the present invention to a CPP-GMR element having the same element area, it is possible to attain an element resistance of at least 3Ω.

An appropriate film thickness for the non-magnetic layer in a CPP-GMR element is 0.8 nm to 10 nm, or even better 1.8 nm to 5 nm. When the non-magnetic layer is too thin, the interlayer coupling between the magnetic layers becomes too strong. On the other hand, when the non-magnetic layer is too thick, it is not possible to attain a large MR ratio.

Applying the present invention to a TMR element, at least one magnetic layer, that is the first magnetic layer or the second magnetic layer, should be provided with the first region and the second region. The nonmagnetic layer in this element is an insulating layer (tunnel insulating layer), preferably including at least one selected from aluminum oxide, aluminum nitride, aluminum oxynitride, magnesium oxide and strontium titanate as the main component, so that it is provided with a sufficiently high element resistance to begin with. However, also in this element, the restriction of the conductive region by the second region is advantageous for making the track response width of a magnetic head using the element narrower. When at least one magnetic layer is, for example, oxidized and taken as the second region, the region supplying the tunnel current in the insulating layer is restricted. Thus, the portion functioning as the element, that is, the region detecting the magnetism from the medium, is effectively restricted.

In order to let the tunnel current flow, an appropriate film thickness of the non-magnetic layer in the TMR element is 0.4 nm to 2 nm, preferably 0.4 nm to 1 nm.

The MR element of the present invention further can include a magnetization rotation control layer magnetically coupled with at least one layer selected from the first magnetic layer and the second magnetic layer. There is no particular limitation to the magnetization rotation control layer as long as it makes the magnetization rotation of the magnetic layer magnetically coupled with it more easy or more difficult. An antiferromagnetic layer can be used as the magnetization rotation control layer, for example.

Using a magnetization rotation control layer, the element of the present invention also can be devised as a so-called spin valve-type MR element. In such an element, the magnetization rotation of one magnetic layer (pinned magnetic layer) is fixed (pinned) by an exchange bias magnetic field with an antiferromagnetic layer, while the magnetization of the other magnetic layer (free magnetic layer) is rotated by an external magnetic field, and changes in the resistance are detected.

The second region can be formed by introducing, for example, oxygen and/or nitrogen into the lateral side of the layer. This step can be performed by heating the layer to at least 100° C. and introducing into the lateral side of the layer a gas including at least one selected from oxygen atoms and nitrogen atoms. The examples of the gas include oxygen gas and nitrogen gas. It is also possible to carry out this process by implanting the lateral side of the layer with at least one selected from oxygen ions and nitrogen ions. There is no particular limitation with regard to the method for ion implantation, and any of the suitable methods known can be used.

In the process for oxidation or the like, the problem may occur that electrodes, and in particular electrodes that have been formed before the non-magnetic layer, are oxidized. In that case, the oxidation or the like should be carried out after forming a protective film covering at least a portion of the electrodes that have been formed beforehand, and preferably not covering the lateral side subjected to oxidation or the like.

In CPP-GMR elements, the step of oxidation or the like should be performed with respect to the lateral side of at least the non-magnetic layer. In TMR elements, on the other hand, it should be performed with respect to the first magnetic layer and/or the second magnetic layer. In both kinds of elements, as long as the operation of the element is not harmed, there is no limitation to which layer is oxidized, nitrided and oxynitrided, and all layers of the first and second magnetic layer and the non-magnetic layer can be oxidized etc. It should be noted that any of oxidation, nitration, and oxynitration can be applied, but oxidation is preferable to obtain a high resistance.

In the following, an example of an MR element applying the present invention is explained with reference to the accompanying drawings. In the MR element 100 shown in FIG. 1, a lower electrode 2, an MR element portion 10, and upper electrodes 3 and 4 are layered in that order on a substrate 1. Furthermore, an insulating film 5 is disposed between the two electrodes. The periphery of the MR element portion 10 is oxidized, forming an oxide region (oxide film) 20. As shown in FIG. 1, the oxide region can extend into portions 2a and 3a of the electrodes 2 and 3, as long as the function of the electrodes is preserved.

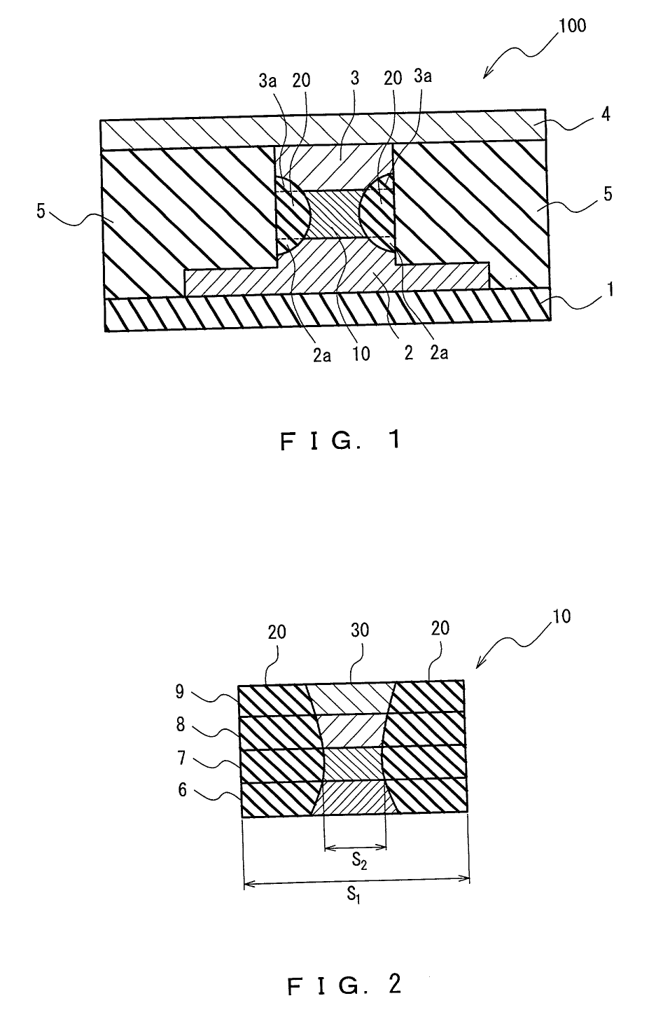

As shown in magnification in FIG. 2, the MR element portion 10 includes a free magnetic layer 6, a non-magnetic layer 7, a pinned magnetic layer 8, and an antiferromagnetic layer 9, layered in that order from the substrate side. These layers are oxidized from the lateral side, so that the current flowing perpendicularly through the various layer films passes not through the oxide region 20, but practically entirely through the nonoxidized region 30 in the middle. It should be noted that in TMR elements, the magnetic layers are insulating layers, but the magnetic layers 6 and 8 are oxidized, so that also in TMR elements the tunneling current flows only through the non-oxidized region 30.

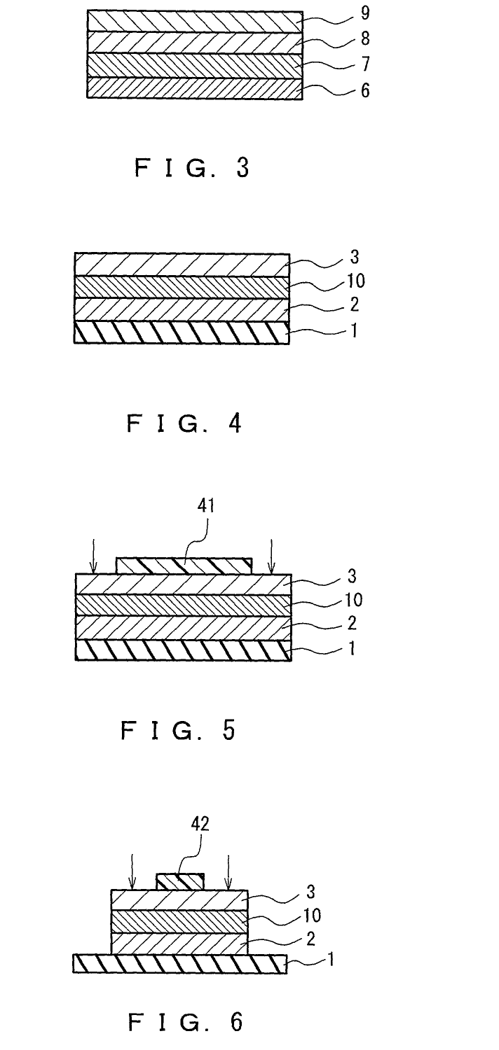

This MR element can be formed by oxidizing the lateral side of the multilayer film shown in FIG. 3. By oxidation, the area of the portion functioning as the element is decreased from the area S₁ to the area S₂. The region functioning as the element strictly speaking can be determined at the interface of the non-magnetic layer and the magnetic layer. Thus, in a preferable embodiment of the present invention, the area S₁ of the non-magnetic layer is first restricted to 0.01 μm² or less by a lithography technique, and then this area is further reduced to S₂ by oxidation or the like. A preferable ratio of (S₁-S₂)/S₁ is at least 0.1, more preferably at least 0.4.

The following lists examples of the materials for the layers. For the free magnetic layer 6, for example, Fe, Ni—Fe, Ni—Co—Fe and Co—Fe alloys are suitable in order to obtain favorable soft magnetic characteristics. Expressing the Ni—Co—Fe composition (by atomic composition ratio; this is the same in the following), as NiₓCo_{y}Fe_{z}, a Ni-rich composition with 0.6≦x≦0.9, 0≦y≦0.4 and 0≦z≦0.3, or a Co-rich composition with 0≦x≦0.4, 0.2≦y≦0.95 and 0≦z ≦0.5 is suitable. Films made of these compositions have the low magnetostrictive properties (magnetostrictive constant ≦1×10⁻⁵) that are demanded of magnetic sensors and MR heads. For the free magnetic layer, it is possible to use an amorphous film having composition of Co—Mn—B, Co—Fe—B, Co—Nb—Zr or Co—Nb—B, for example.

The film thickness of the free magnetic layer 6 should be 1 nm to 10 nm. When the film is too thick, then the resistance that is not imparted to the MR increases and the MR ratio decreases, and when the film is too thin, the soft magnetic properties deteriorate.

For the non-magnetic layer 7 of CPP-GMR elements, a non-magnetic metal material is used. For the non-magnetic layer 7 of TMR elements, an insulating material is used. Preferable materials and film thicknesses are as in the examples described above.

Depending on the material of the free magnetic layer, Fe, Co, Co—Fe alloys (especially Co₁₋ₓFeₓ with 0<x ≦0.5) and Co—Ni—Fe alloys are suitable as the material of the pinned magnetic layer 8, because large MR ratios can be achieved with these materials. If Cr is used as the non-magnetic layer, then Fe is preferable. In that case, it is suitable to use Fe also for the free magnetic layer. When Co₁₋ₓFeₓ alloys are used together with Cu as the non-magnetic layer, then the diffusion depending on the spin increases, and a large MR ratio can be attained.

When the pinned magnetic layer 8 is too thin, the MR ratio decreases, and when it is too thick, the exchange bias magnetic field decreases, so that its thickness should be 1 nm to 10 nm.

As the material for the antiferromagnetic layer 9, it is suitable to use at least one selected from Fe—Mn, Ni—Mn, Pd—Mn, Pt—Mn, Ir—Mn, Cr—Al, CrMn—Pt, Fe—Mn—Rh, Pd—Pt—Mn, Ru—Rh—Mn, Mn—Ru and Cr—Al. With regard to corrosion resistance and thermal stability, it is preferable to use a Mn based antiferromagnetic material, more specifically Ni—Mn, Ir—Mn or Pt—Mn, of which Pt—Mn is particularly preferable. Taking Pt₂Mn_{1-z} as the composition, a range of 0.45≦z ≦0.55 is preferable. It is preferable that the thickness of the antiferromagnetic film is at least 5 nm, more preferably at least 10 nm, in order to enhance the bias effect.

If Cu is used as the non-magnetic layer, then it is preferable that Co or Co—Fe alloy is introduced as an interface magnetic layer at the interface between the ferromagnetic films (free layer 6 and pinned layer 8) and the non-magnetic layer 7, because this makes the MR ratio even larger. The film thickness of the interface magnetic layers should be not more than 2 nm, preferably not more than 1 nm, because the magnetic field sensitivity of the MR ratio is decreased when they are too thick. On the other hand, when they are too thin, the MR ratio does not increase, so that they should be at least 0.4 nm.

In order to increase the bias magnetic field imparted on the pinned magnetic layer 8, or in other words to stabilize the magnetization direction of the pinned layer, an indirectly exchange coupled film made of the three layers ferromagnetic layer/non-magnetic layer/ferromagnetic layer may be used for the pinned magnetic layer. In an indirectly exchange coupled film, selecting suitable materials and film thicknesses for the ferromagnetic layers and the non-magnetic layer, a large antiferromagnetic coupling occurs between the ferromagnetic layers, and the magnetization of the pinned magnetic layer is stabilized.

Suitable materials for the ferromagnetic layers constituting the indirectly exchange coupled film include Co, Co—Fe, and Co—Fe—Ni alloys, and Co and Co—Fe alloys are particularly favorable. As the material for the intermediate non-magnetic layer, Ru, Ir, Rh etc. are suitable, and Ru is particularly favorable. It is preferable that the thickness of the ferromagnetic layer is 1 nm to 4 nm. For the thickness of the non-magnetic layer, 0.3 nm to 1.2 nm and particularly 0.4 nm to 0.9 nm are appropriate.

For the lower electrode 2 and the upper electrodes 3 and 4, it is preferable to use non-magnetic metal materials, such as Au, Ag, Cu, Pt, Ta or Cr.

The configuration of the MR element portion 10 is not limited to that shown in FIG. 2 and FIG. 3. For example, it is also possible to layer more non-magnetic and magnetic layers in alternation. In that case, at least one group of magnetic layer/non-magnetic layer/magnetic layer should have the configuration described above.

Next, an example of a method for manufacturing an MR element in accordance with the present invention is explained with reference to the accompanying drawings.

First, as shown in FIG. 4, a lower electrode 2, an MR element portion 10, and an upper electrode 3 are layered in that layer on a substrate 1. Then, as shown in FIG. 5, a photoresist 41 is applied and exposed, and the lower electrode 2 is shaped into a predetermined form by ion milling. Then, as shown in FIG. 6, another photoresist 42 is applied and exposed, and the area of the non-magnetic layer in the MR element portion 10 is shaped by ion milling to an area of 1 μm² or less. It should be noted that this ion milling should be carried out to a point where a portion of the lower electrode 2 is milled away.

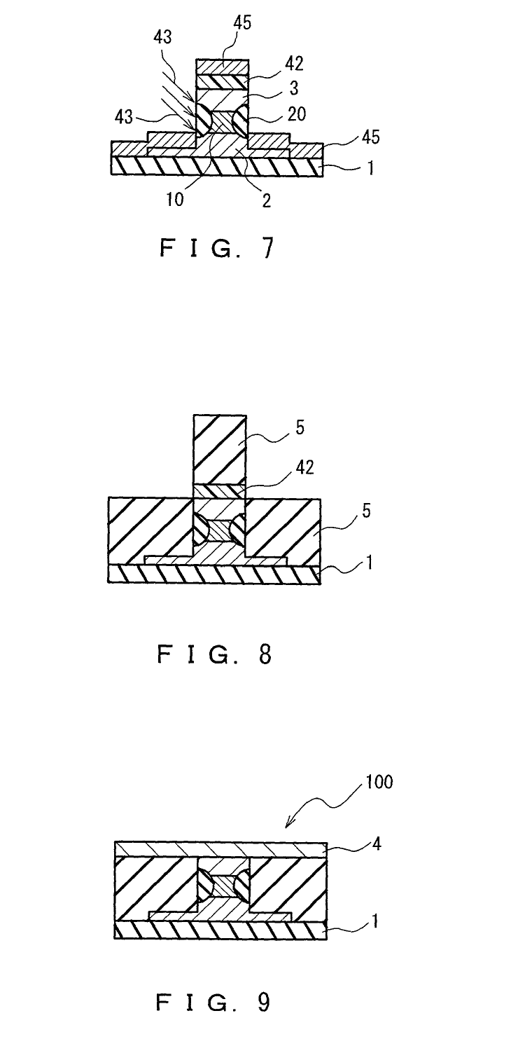

After that, as shown in FIG. 7, an insulating film 45 is formed by vapor deposition as a protective film, and then an implantation with oxygen ions 43 is performed. The oxygen ions should be applied from a diagonal direction with respect to the film surface, so that the lateral side of the element 10 is oxidized. If necessary, it is also possible to introduce oxygen gas to the lateral side of the element while heating it in a vacuum. The lateral side of the element becomes amorphous due to the ion implantation, so that when oxygen is introduced to the lateral side, the oxide film 20 can be formed easily.

The method for forming the oxide film 20 is not limited to ion implantation, and it is also possible to heat the element to at least 100° C. and introduce an oxygen gas to the lateral side of the element. Furthermore, as long as it does not compromise the object of the present invention, it is also possible to use plasma oxidation or natural oxidation. Instead of an oxide film, it is also possible to form a nitride film or an oxynitride film.

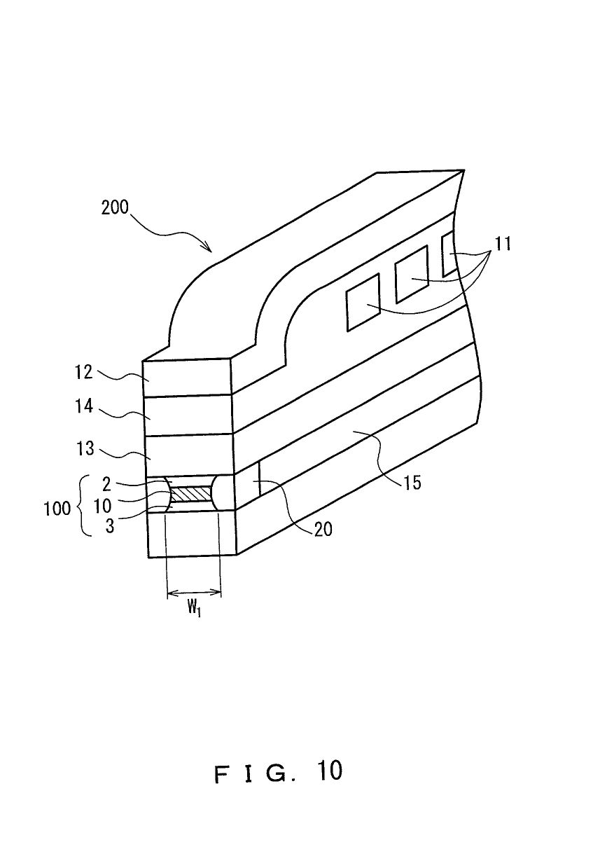

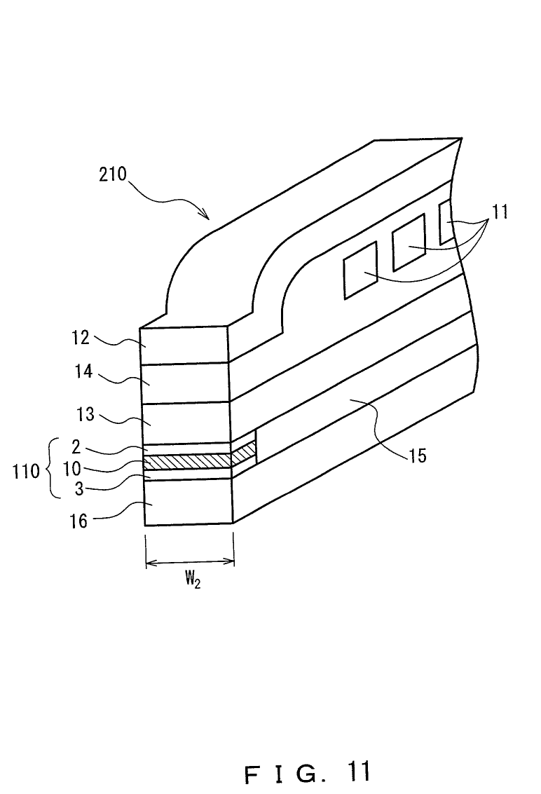

After the oxidation, an insulating film 5 is formed by vapor deposition, as shown in FIG. 8. As shown in FIG. 8, it is also possible to take a previously formed protective insulating film 45 as a portion of the insulating film 5. As shown in FIG. 9, after lifting off excess portions of the insulating film 5, an additional upper electrode 4 is formed by vapor deposition, for example. This finishes the MR element 100. It should be noted that the film formation of the layers can be accomplished with any suitable conventional method. For example, the layers of the MR element portion 10 can be formed by sputtering or vapor deposition.

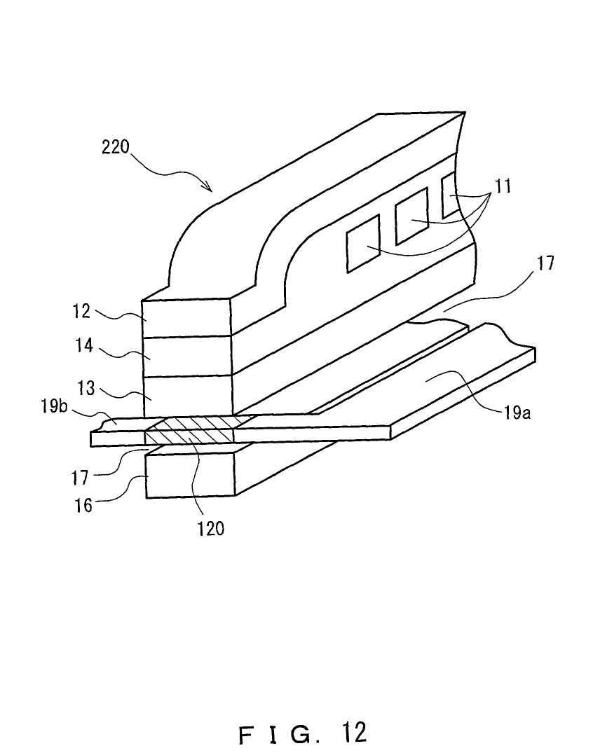

FIG. 10 shows an example of an MR head using this MR element 100. As shown in FIG. 12, in an MR head 220 using a CIP-GMR element, the current flows parallel to the film surface of the MR element 120 between electrodes 19a and 19b, but in the MR head 200 of FIG. 10, the current flows vertically through the films of the MR element 100. As shown in FIG. 11, an MR head 210 in which the current flows vertically through the films of the element is known from the related art, but in the MR head in FIG. 10, the track response width W₁ of the head is narrower than the conventional track response width W₂. It is preferable that the track response width W₁ is 0.1 μm or less, more preferably 0.01 to 0.1 μm.

In the MR head 220 of FIG. 12, an insulating region 17 is necessary in order to ensure insulation between the magnetic shields 13 and 16 (and ordinarily, an insulating film can be used for this). On the other hand, in the magnetic head in FIG. 10, it is possible to eliminate the electrodes 2 and 3 by using an upper magnetic shield 13 and a lower magnetic shield 15 as electrodes. Thus, using as electrodes magnetic shields in which the flow of excessive magnetic fields other than the signal magnetic fields into the MR element is inhibited, it is easy to accommodate the narrower gaps that come with higher recording densities.

With these magnetic heads, a write head (recording head) that shares one of the magnetic shields with the read head (reproduction head) is arranged next to the read. The write head includes a recording pole (upper shield) 12, a common shield 13, an insulating film 14 disposed between these two shields, and a coil 11.

For the upper, common and lower magnetic shields 12, 13 and 16, it is suitable to use soft magnetic films, such as Ni—Fe, Fe—Al—Si or Co—Nb—Zr alloys. For the insulating films 14 and 15, Al₂O₃, AlN or SiO₂ are suitable.

In order to suppress Barkhausen noise, ferromagnetic bias layers, for example made of Co—Pt (not shown in the drawings), should be arranged on both sides of the magnetoresistive element 10.

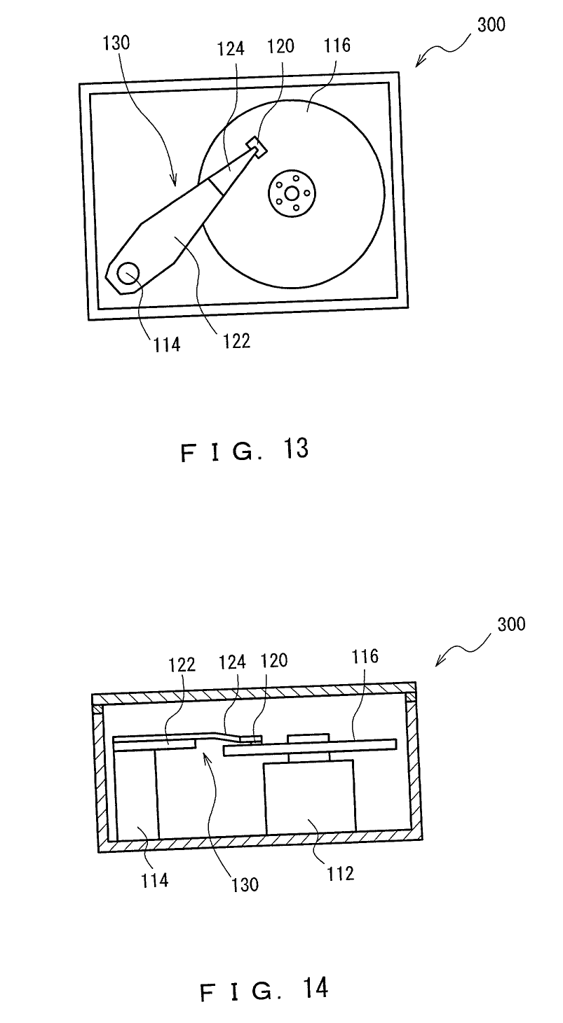

FIG. 13 and FIG. 14 are a plan view and a lateral view of a hard disk device 300 using the above-described MR head 200. This hard disk device 300 includes a slider 120 having an MR head, a head support mechanism 130 supporting the slider, an actuator 114 for tracking with the MR head via the head support mechanism 130, and a disk driving motor 112 rotating a magnetic disk 116 for recording/reproducing of information with the head. The head support mechanism 130 is provided with an arm 122 and a suspension 124.

The disk driving motor 112 rotates the disk 116 at a predetermined speed. The actuator 114 moves the slider 120 holding the head in a radial direction across the disk 116, so that the MR head accesses a predetermined data track on the disk. The actuator 114 can be a linear or rotary voice coil motor, for example. The slider 120 can be an air-bearing slider, for example. In that case, the slider 120 touches the surface of the disk 116 when the hard disk device 300 starts or stops. On the other hand, during the recording/reproducing operation, the slider 120 floats above the surface of the disk, carried by an air cushion that is formed between the rotating disk 116 and the slider 120. In that situation, information is recorded on and/or reproduced from the magnetic disk 116 with the MR head 200.

### Examples

### Working Example 1

An MR element portion was formed with a multi-target sputtering device. The MR element portion was devised as a so-called dual spin-valve structure in which pinned layers are arranged on both sides of a free layer, separated by non-magnetic layers. The layering configuration of the element is shown below, including substrate and electrodes. substrate/Au(500)/Pt_{0.5}Mn_{0.5}(30)/CoFe(3)/Ru(0.7)/CoFe(3)/Cu(3)/ CoFe(2)/NiFe(5)/CoFe(2)/Cu(3)/CoFe(3)/Ru(0.7)/CoFe(3)/Pt_{0.5}Mn_{0.5}(30)/ Au(500)

The figures in parentheses denote the film thicknesses (in nm; this is also true in the following).

Cu serves as the non-magnetic layer, PtMn serves as the antiferromagnetic layer, and Au serves as the electrodes. For the substrate, Si with a thermally oxidized surface was used.

The CPP-GMR element obtained in this manner was processed into an MR element with the method explained above with reference to FIG. 4 to FIG. 9. The size of the patterning with photoresist was 100 nm×100 nm. SiO₂ films were used for the insulating films 5 and 45 in FIGS. 7 and 8. The oxide film 20 was formed by implanting oxygen ions at 30 keV at an angle of ca. 45° with respect to the film surface. The implantation level of the oxygen ions was set to 1×10¹⁵ ions/cm². When sufficient oxidation cannot be attained by ion implantation, it is also possible to introduce oxygen gas after heating to 200 to 300° C. in a vacuum. Thus, when oxidation was performed from one lateral side of the element, a Cu oxide film was formed in the non-magnetic layer to a depth of 45 nm from the lateral side. The oxidation also can be carried out from both sides, as shown in the drawings,

Together with the MR element (element A) obtained in this manner, an MR element (element B) was made as described above, except that the process of oxidizing the lateral sides was omitted. The magnetoresistive properties of the two elements were evaluated by the four-terminals method, applying a magnetic field of 500 Oe (ca. 39.8 kA/m) at room temperature. The element A, in which the lateral sides were oxidized, had a resistance of 3Ω, a resistance change of 0.9Ω and an MR ratio of 30%, whereas the conventional element B had a resistance of 1.5Ω, a resistance change of 0.45Ω and an MR ratio of 30%. Thus, it was confirmed that oxidizing the lateral sides doubles the resistance change.

Then, MR head 200 and 210 as shown in FIG. 10 and FIG. 11 were manufactured. Ni_{0.8}Fe_{0.2} alloy was used for the magnetic shields, and A1₂O₃ was used for the insulating films. The electrodes were substituted by the magnetic shields. Moreover, an Al₂O₃—TiC substrate was used for the substrate on which the layers were formed. A dc current was sent as a sensor current through the resulting two heads, and the output of the heads when applying an ac signal magnetic field of about 4 kA/m was evaluated. The output of the MR head corresponding to FIG. 10 was about twice as high as the output of the MR head corresponding to FIG. 11.

### Working Example 2

An MR element portion 10 was formed with a multi-target sputtering device. The layering configuration of the element is shown below, including substrate and electrodes. substrate/Au(500)/Pt_{0.5}Mn_{0.5}(30)/CoFe(3)/Ru(0.7)/CoFe(3)/Al₂O₃(0.8)/ CoFe(2)/NiFe(5)/Au(500) The non-magnetic Al₂O₃ film was formed by natural oxidation of Al. The resulting TMR element portion was processed into an MR element in the same manner as in Working Example 1, making an MR element with oxidized lateral faces (element C) and an MR element in which the process for oxidizing the lateral face was omitted (element D).

When the two elements were examined with a transmission electron microscope, it was found that in element C, the two magnetic layers sandwiching the non-magnetic layer were oxidized from the lateral sides. The width of the non-oxidized region was about 50 nm. On the other hand, in element D, no oxidized region could be observed, and the width of the region functioning as the element was about 100 nm.

Thus, in accordance with the present invention, in MR elements, in which the current flows perpendicular to the films, the electric resistance can be raised to a practical range, and the track width can be made narrow to a degree that is difficult to attain with lithography methods.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A magnetoresistive element comprising:
a non-magnetic layer; and
a first and a second magnetic layer sandwiching the non-magnetic layer;
wherein a current for sensing a change in magnetic resistance based on a change in the relative angle between a magnetization direction of the first magnetic layer and a magnetization direction of the second magnetic layer flows perpendicular with respect to the layers;
wherein the non-magnetic layer has an area of not more than 1 μm²;
wherein at least one layer selected from the first and second magnetic layers and the non-magnetic layer includes a first region through which said current flows and a second region made of an oxide, a nitride or an oxynitride of the material of which the first region is made; and
wherein the first region is smaller than an area of the non-magnetic layer.

2. The magnetoresistive element according to claim 1, wherein the second region accounts for at least 10% of the non-magnetic layer.

3. The magnetoresistive element according to claim 1, wherein the area of the non-magnetic layer is not larger than 0.1 μm².

4. The magnetoresistive element according to claim 1, wherein at least the non-magnetic layer has the first region and the second region.

5. The magnetoresistive element according to claim 4, wherein the first region of the non-magnetic layer has at least one main component selected from the group consisting of Cu, Ag, Au, Ir, Ru, Rh and Cr.

6. The magnetoresistive element according to claim 4, wherein the non-magnetic layer is at least 0.8 nm and at most 10 nm thick.

7. The magnetoresistive element according to claim 1, wherein at least the first magnetic layer and the second magnetic layer have the first region and the second region.

8. The magnetoresistive element according to claim 7, wherein the non-magnetic layer is an insulating layer.

9. The magnetoresistive element according to claim 7, wherein the non-magnetic layer has at least one main component selected from aluminum oxide, aluminum nitride, aluminum oxynitride, magnesium oxide and strontium titanate.

10. The magnetoresistive element according to claim 7, wherein the non-magnetic layer is at least 0.4 nm and at most 2 nm thick.

11. The magnetoresistive element according to claim 1, further comprising a magnetization rotation control layer magnetically coupling with at least one layer selected from the first magnetic layer and the second magnetic layer.

12. The magnetoresistive element according to claim 11, wherein the magnetization rotation control layer is an antiferromagnetic layer.

13. A method for manufacturing a magnetoresistive element comprising a non-magnetic layer, and a first and a second magnetic layer sandwiching the non-magnetic layer, wherein a current for sensing a change in magnetic resistance based on a change in the relative angle between a magnetization direction of the first magnetic layer and a magnetization direction of the second magnetic layer flows perpendicular with respect to the layers; the method comprising:
forming the first magnetic layer, the non-magnetic layer, and the second magnetic layer such that the non-magnetic layer has an area of not more than 1 μm²; and
oxidizing, nitriding or oxynitriding a portion of at least one layer selected from the first magnetic layer, the non-magnetic layer, and the second magnetic layer from a lateral side.

14. The method for manufacturing a magnetoresistive element according to claim 13, wherein the oxidizing, nitriding or oxynitriding is performed by heating said layer to at least 100° C., and introducing a gas including at least one selected from oxygen atoms and nitrogen atoms into the lateral side of said layer.

15. The method for manufacturing a magnetoresistive element according to claim 13, wherein the oxidizing, nitriding or oxynitriding is performed by implanting the lateral side of said layer with at least one selected from oxygen ions and nitrogen ions.

16. The method for manufacturing a magnetoresistive element according to claim 13, further comprising
forming an electrode for conducting the current; and
forming a protective film covering at least a portion of the electrode;
wherein a portion of said layer is oxidized, nitrided or oxynitrided after forming the protective layer.

17. The method for manufacturing a magnetoresistive element according to claim 13, wherein a layer having at least one main component selected from the group consisting of Cu, Ag, Au, Ir, Ru, Rh and Cr is formed as the non-magnetic layer.

18. The method for manufacturing a magnetoresistive element according to claim 17, wherein at least a lateral side of the non-magnetic layer is oxidized, nitrided or oxynitrided.

19. The method for manufacturing a magnetoresistive element according to any of claims 13 to 16, wherein an insulating layer is formed as the non-magnetic layer.

20. The method for manufacturing a magnetoresistive element according to claim 19, wherein at least a lateral side of the first magnetic layer or the second magnetic layer is oxidized, nitrided or oxynitrided.

21. A magnetoresistive head comprising:
a magnetoresistive element according to claim 1; and
a pair of magnetic shields arranged so as to sandwich the magnetoresistive element.

22. The magnetoresistive head according to claim 21, wherein a region for detecting magnetism from a magnetic recording medium is not more than 0.1 μm wide.

23. A magnetic recording apparatus comprising:
a magnetoresistive head according to claim 21; and
a magnetic recording medium for recording or reproducing information with the magnetic head.
